(19) United States
(12) Patent Application Publication
(10) Pub. No.: US 2007/0008744 A1
(43) Pub. Date: Jan. 11, 2007

(54) HIGH EFFICIENCY HALF-BRIDGE DC/DC CONVERTOR

(75) Inventors: TAE WON HEO, KYUNGKI-DO (KR); DONG KYUN RYU, CHUNLABOOK-DO (KR); YOICHI OKADA, KYUNGKI-DO (KR); KIYOKAZU NAGAHARA, KYUNGKI-DO (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/456,053

(22) Filed: Jul. 6, 2006

(30) Foreign Application Priority Data
Jul. 7, 2005 (KR) 10-2005-61292
Jun. 14, 2006 (KR) 10-2006-53634

(51) Int. Cl. H02M 3/335; H02M 7/5387

(52) U.S. Cl. 363/17; 363/132

(57) ABSTRACT

In the DC/DC converter, a switching part has first and second switches serially connected from a power supply to a ground. The first and second switches switch on/off in response to first and second switching signals having a fixed frequency. The first switching signal has a phase level that does not overlap a corresponding phase level of the second switching signal. A transformer transforms a voltage applied to a first winding into a second winding in response to switching operation of the switching part, and resonates by an inductor and a capacitor of the first winding. Also, a rectifier includes a rectifying diode for rectifying the voltage from the transformer into a direct voltage. A feedback circuit detects the voltage outputted via the rectifier. Additionally, a controller controls pulse width of the first and second switching signals in a PWM mode according to the voltage detected by the feedback circuit.

### CLAIM OF PRIORITY

This application claims the benefit of Korean Patent Application Nos. 2005-61292 filed on Jul. 7, 2005 and 2006-53634 filed on Jun. 14, 2006 in the Korean Intellectual Property Office, the disclosure of which is incorporated herein by reference.

### BACKGROUND OF THE INVENTION

1. Field of the Invention

The present invention relates to a high-efficiency DC/DC converter for use in a power supply of displays such as PDP or LCD, and more particularly, to a high-efficiency half-bridge DC/DC converter which can operate with a fixed switching frequency, a Pulse Width Modulation (PWM) mode and current resonance in order to ensure high efficiency in the entire range from a minimum load to a maximum load when applied to a power supply such as an SMPS for PDP having big load variations, and to reduce switching stress of a rectifying diode.

2. Description of the Related Art

In general, a Switching Mode Power Supply (SMPS) is a power supply device for converting a direct voltage into a square wave voltage by utilizing a semiconductor device such as a power Metal Oxide Semiconductor Field Effect Transistor (MOSFET) as a switch and then supplying a direct output voltage converted via a filter.

Such an SMPS controls current flow via a switching processor of the semiconductor device. Accordingly, the SMPS, as a stabilized power supply device, is more efficient, durable than a conventional linear power supply device, advantageous for smaller size and lighter weight.

An asymmetric half-bridge DC/DC converter included in the conventional power supply device will be explained with reference to FIG. 1.

FIG. 1 illustrates the conventional asymmetric half-bridge DC/DC converter.

The conventional asymmetric half-bridge (AHB) DC/DC converter of FIG. 1 is an asymmetric fixed frequency pulse width modulation converter. The AHB DC/DC converter includes a switching controller 21, a switching part 22, a transformer 23, a rectifier 24 and a feedback circuit 25. The switching controller 21 provides asymmetric first and second switching signals SSW1 and SSW2 having a fixed frequency. Here, a high level of the first switching signal SSW1 does not overlap that of the second switching signal SSW2. Likewise, a low level of the first switching signal SSW1 does not overlap that of the second switching signal SSW2. The switching part 22 has first and second switches Q1 and Q2 serially connected from a power supply Vin to a ground. The first switch Q1 switches on/off in response to the first switching signal SSW1, and the second switch Q2 switches on/off in response to the second switching signal SSW2. The transformer 23 transforms a voltage applied to a first winding into a second winding in response to switching operation of the switching part 22. The rectifier 24 rectifies and smoothes the voltage from the transformer 23. Also, the feedback circuit 25 detects the voltage outputted via the rectifier 24 and the output voltage to the switching controller 21, thereby maintaining it at a predetermined level.

This conventional asymmetric half-bridge DC/DC converter problematically suffers stress in a diode of the rectifier, which will be explained with reference to FIG. 2.

FIG. 2 is a waveform diagram illustrating diode current and voltage of the asymmetric half-bridge DC/DC converter of FIG. 1. As shown in FIG. 2, a first diode D1 of the rectifier is turned on when current is not zero. Meanwhile, a second diode D2 of the rectifier is turned off when current is not zero. At this time, the first diode D1 has a high level of voltage VD1, generating stress in the first and second diodes D1 and D2 of the rectifier and thus undermining efficiency.

FIG. 3 is a configuration view illustrating a conventional resonant DC/DC converter.

The conventional resonant DC/DC converter as shown in FIG. 3 is a symmetric fixed duty ratio frequency modulation converter. The conventional resonant DC/DC converter includes a switching controller 31, a switching part 32, a transformer 33, a rectifier 4 and a feedback circuit 35. The switching controller 31 provides symmetrical first and second switching signals SSW1 and SSW2 having a fixed frequency. Here, a high level of the first switching signal SSW1 does not overlap that of the second switching signal SSW2. Likewise, a low level of the first switching signal SSW1 does not overlap that of the second switching signal SSW2. The switching part 32 has first and second switches Q1 and Q2 connected from a power supply Vin to a ground. The first switch Q1 switches on/off in response to the first switching signal SSW1 and the second switch Q2 switches on/off in response to the second switching signal SSW2. The transformer 23 transforms a voltage applied to a first winding into a second winding in response to switching operation of the switching part 32 and resonates by inductors Lr and Lm and a capacitor Cr of the first winding. The rectifier 34 rectifies and smoothes the voltage from the transformer 33. Also, the feedback circuit 35 detects the voltage outputted via the rectifier 34 and provides the output voltage to the switching controller 31, thereby maintaining it at a predetermined level.

In such a conductor, inductance of the inductors Lr and Lm and capacitance of the capacitor Cr of the first winding, which constitute the transformer, resonate each other. Then if a switching signal provided to the second switch Q2 turns to a low level, the second switch Q2 is turned off. At this time, current flows to the transformer via the first switch Q1 until the second switch Q2 is turned on.

However, the conventional variable frequency symmetric resonant converter, when applied to a power supply such as the SMPS for PDP having big load variations, experiences increase in frequency at a minimum load, which however excessively shortens switching-on time thereof. Therefore, the conventional variable frequency symmetric resonant converter switches off before current flows enough to excite circulating current of a resonance tank. Accordingly, energy from a primary coil of the transformer is hardly transferred to a secondary coil thereof, thereby degrading efficiency.

### SUMMARY OF THE INVENTION

The present invention has been made to solve the foregoing problems of the prior art and therefore an object according to certain embodiments of the present invention is to provide a high-efficiency half-bridge DC/DC converter which can operate with a fixed switching frequency, a PWM mode and current resonance in order to ensure high efficiency in the entire range from a minimum load to a maximum load when applied to a power supply such as an SMPS for PDP having big load variations and to reduce switching stress of a rectifying diode.

According to an aspect of the invention for realizing the object, there is provided a high efficiency half-bridge DC/DC converter comprising: a switching part having first and second switches serially connected from a power supply to a ground, the first and second switches switching on/off in response to first and second switching signals having a fixed frequency, the first switching signal having a phase level that does not overlap a corresponding phase level of the second switching signal; a transformer for transforming a voltage applied to a first winding into a second winding in response to switching operation of the switching part, and resonating by an inductor and a capacitor of the first winding; a rectifier including a rectifying diode for rectifying the voltage from the transformer into a direct voltage; a feedback circuit for detecting the voltage outputted via the rectifier; and a controller for controlling pulse width of the first and second switching signals in a pulse width modulation mode according to the voltage detected by the feedback circuit.

The controller sequentially controls the pulse width of the first and second switching signals, in a first operation mode, by stabilizing switching on/off state of the first and second switches and starting current to flow forwardly to charge the capacitor, in a second operation mode, by switching on/off the first and second switches so that current begins to flow inversely and gradually decreases in the second switch to completely charge the capacitor, a third operation mode, by stabilizing the switching on/off state of the first and second switches and starting to discharge the charged capacitor so that current flows forwardly in the second switch, and in a fourth operation mode, by switching on/off the first and second switches to completely discharge the capacitor.

The first switch is in a zero voltage state while current flows inversely through a body diode at off state, and switches on from the zero voltage state.

The second switch is in a zero voltage state when current flows inversely through the body diode at off state, and switches on from the zero voltage state.

Current flowing in the rectifying diode is synchronized with resonance of the transformer so that the rectifying diode in the rectifier executes zero-current switching.

According to another aspect of the invention for realizing the object, there is provided a method for controlling a high efficiency half-bridge DC/DC converter, which includes a switching part having first and second switches serially connected from a power supply to a ground, a transformer for transforming a voltage applied to a first winding into a second winding in response to switching operation of the switching part, and resonating by an inductor and a capacitor of the first winding, a rectifier having a rectifying diode for rectifying the voltage from the transformer into a direct voltage, a controller for controlling pulse width of the first and second switching signals having a fixed frequency in a pulse width modulation mode, the method executing: a first operation mode of stabilizing switching on/off state of the first and second switches and starting current to flow forwardly to charge the capacitor; a second operation mode of switching on/off the first and second switches so that current begins to flow inversely and gradually decreases in the second switch to completely charge the capacitor and switching the second switch on from a zero voltage state; a third operation mode of stabilizing the switching on/off state of the first and second switches and starting to discharge the charged capacitor so that current flows forwardly in the second switch; and a fourth operation mode of switching on/off the first and second switches to completely discharge the capacitor and switching the first switch on from the zero voltage state while current flows inversely in the first switch so that current flowing inversely in the first switch decreases, wherein the first, second, third and fourth operation modes are executed consecutively and cyclically.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration view illustrating a conventional asymmetric half-bridge DC/DC converter;

FIG. 2 is a waveform diagram illustrating current and voltage of the asymmetric half-bridge DC/DC converter of FIG. 2;

FIG. 3 is a configuration view illustrating a conventional resonant DC/DC converter;

FIG. 4 is a configuration view illustrating a high-efficiency DC/DC converter according to the invention;

FIG. 5 is a waveform diagram illustrating major signals in operating a fixed frequency of the high efficiency DC/DC converter according to the invention;

FIG. 6 is a waveform diagram illustrating diode current of the resonant DC/DC converter of FIGS. 4 and 5;

FIG. 7a is a waveform diagram illustrating major signals of the conventional resonant DC/DC converter at a minimum load, and FIG. 7b is a waveform diagram illustrating major signals of the converter of the invention at a minimum load;

FIGS. 8 (a) to (d) are circuit diagrams corresponding to the switching operation of FIG. 4;

FIGS. 9 (a) to (b) are graphs illustrating efficiency of the conventional resonant DC/DC converter of FIG. 3 and a DC/DC converter of the invention, respectively; and

FIG. 10 is a flow chart illustrating a method for controlling a high efficiency half-bridge DC/DC converter of the invention.

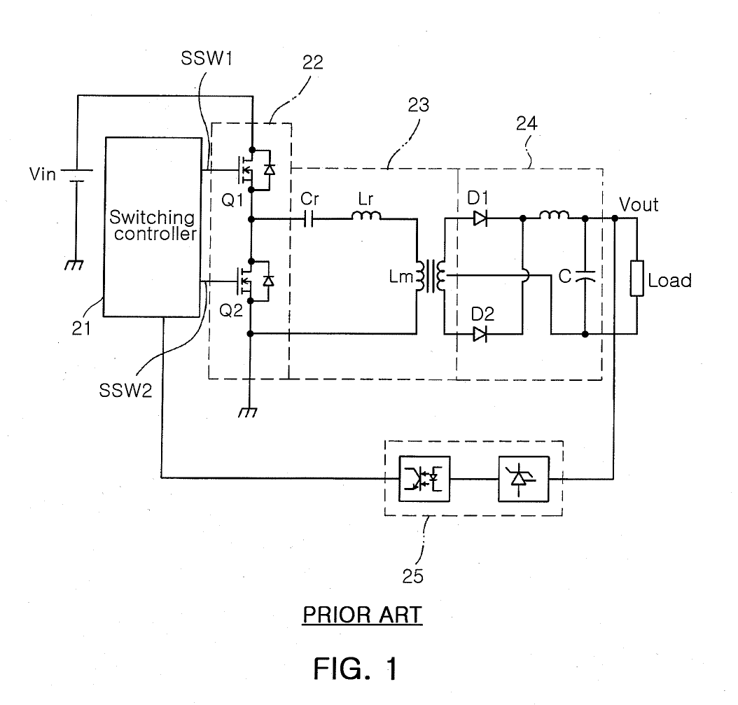

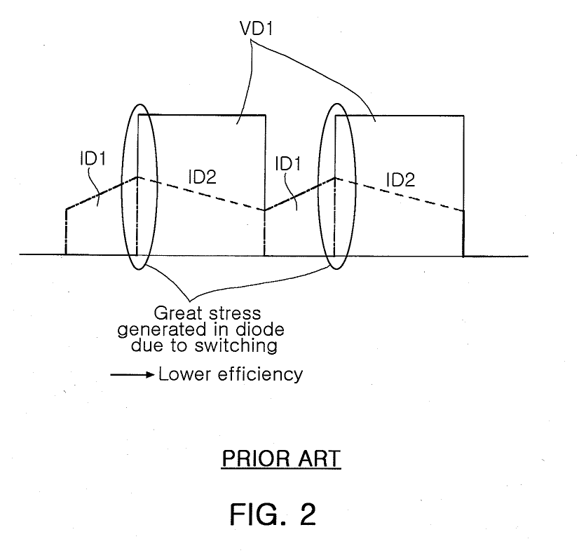

### DETAILED DESCRIPTION OF THE PREFERRED EMBODIMENT

Preferred embodiments of the present invention will now be described in detail with reference to the accompanying drawings, in which the same reference numerals are used throughout the different drawings to designate the same or similar components.

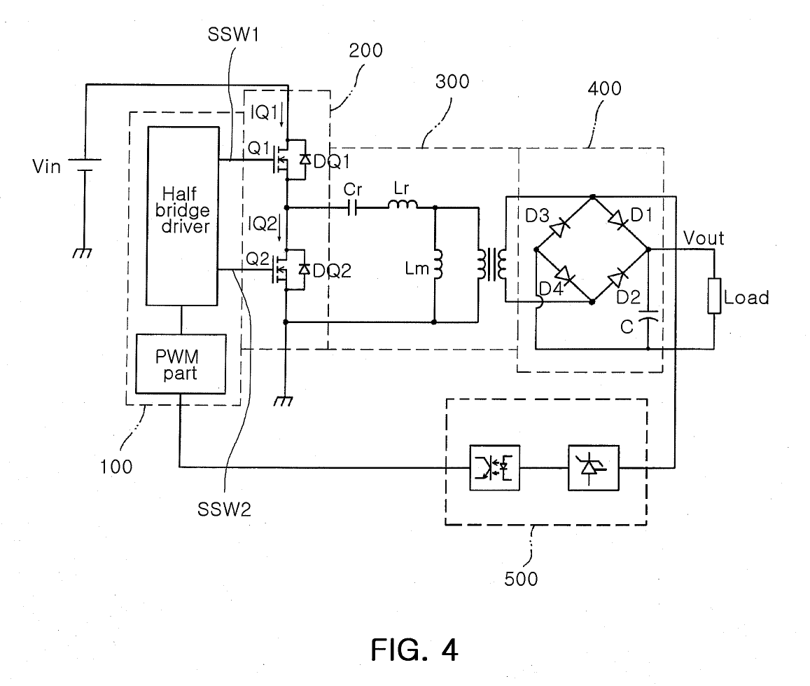

FIG. 4 is a configuration view illustrating a half-bridge DC/DC converter according to the invention.

Referring to FIG. 4, the high-efficiency half-bridge DC/DC converter of the invention includes a controller 100, a switching part 200, a transformer 300, a rectifier 400 and a feedback circuit 500.

The controller 100 provides asymmetric first and second switching signals SSW1, SSW2 having variable pulse width. Here, a high level of the first switching signal SSW1 does not overlap that of the second switching signal SSW2. Likewise, a low level of the first switching signal SSW1 does not overlap that of the second switching signal SSW2. The controller 100 varies pulse width of the first and second switching signals SSW1, SSW2 in the PWM mode depending on size of an output voltage.

The switching part 200 includes first and second switches Q1 and Q2 serially connected from a power supply Vin to a ground. The first switch SSW1 switches on/off in response to a first switching signal SSW1 and the second switch SSW2 switches on/off in response to a second switching signal SSW2.

The transformer 300 transforms a voltage applied to a first winding into a second winding in response to switching operation of the switching part 200. In addition, current resonates by inductance from inductors Lr and Lm and capacitance from a capacitor Cr of the first winding.

The rectifier 400 rectifies the voltage from the transformer 300 into a direct voltage.

In order to maintain the output voltage at a predetermined level, the feedback circuit 500 detects the voltage outputted via the rectifier 400 and provides it to the controller 100.

Furthermore, the controller 100 executes first to fourth operation modes OM1 to OM4 consecutively and cyclically according to levels of the first and second switching signals SSW1, SSW2. In the first operation mode OM1, switching on/off state of the first and second switches Q1, Q2 are stabilized and current starts to flow forwardly to charge the capacitor Cr. In the second operation mode OM2, the first and second switches Q1, Q2 are switched on/off so that current begins to flow inversely and gradually decreases in the second switch Q2 to completely charge the capacitor Cr. In the third operation mode OM3, the switching on/off state of the first and second switches are stabilized and the charged capacitor Cr starts to discharge so that current flows forwardly in the second switch Q2. Also, in the fourth operation mode, the first and second switches Q1 and Q2 are switched on/off to completely discharge the capacitor Cr.

The first switch Q1 is in a zero voltage state while current flows inversely through a body diode at off state and switches on from the zero voltage state. The second switch Q2 is in a zero voltage state while current flows inversely through the body diode at off state and switches on from the zero voltage state.

In this fashion, the first and second switches Q1, Q2 execute zero voltage switching (ZVS).

In addition, current flowing in the rectifying diode of the rectifier 400 is synchronized with resonance of the transformer so that the rectifying diode in the rectifier 400 executes zero-current switching. Such zero current switching alleviates switching stress of the diode of the rectifier 400.

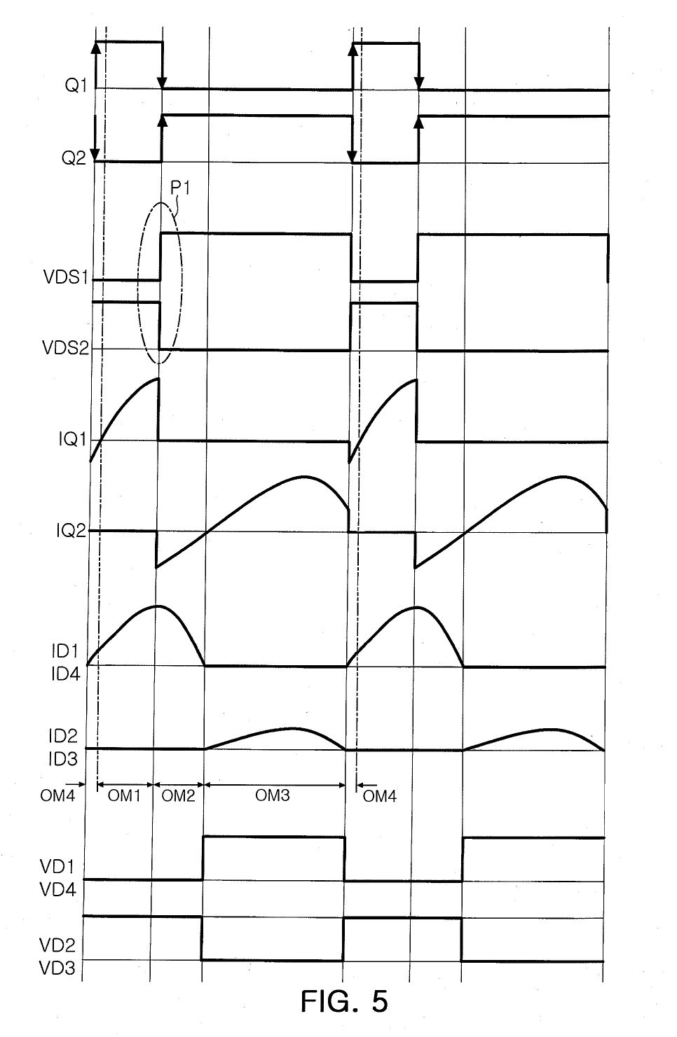

FIG. 5 is a waveform diagram illustrating major signals in operating a fixed frequency of a high efficiency half-bridge DC/DC converter of the invention. FIG. 5 plots waveforms of major signals at a maximum load.

In FIG. 5, P1 denotes a range where the first and second switches Q1 and Q2 are turned on from off or turned off from on.

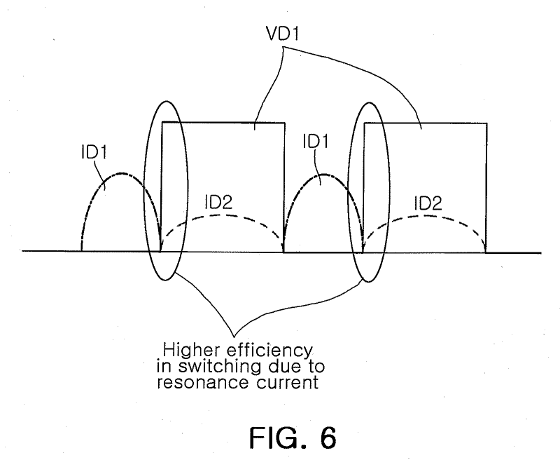

FIG. 6 is a waveform diagram illustrating current of the resonant DC/DC converter of FIGS. 4 and 5. In FIG. 6, VD1 is a voltage charged on a first diode D1 of the rectifier, ID1 is current flowing in the first diode D1 of the rectifier and ID2 is current flowing in a second diode D2 of the rectifier.

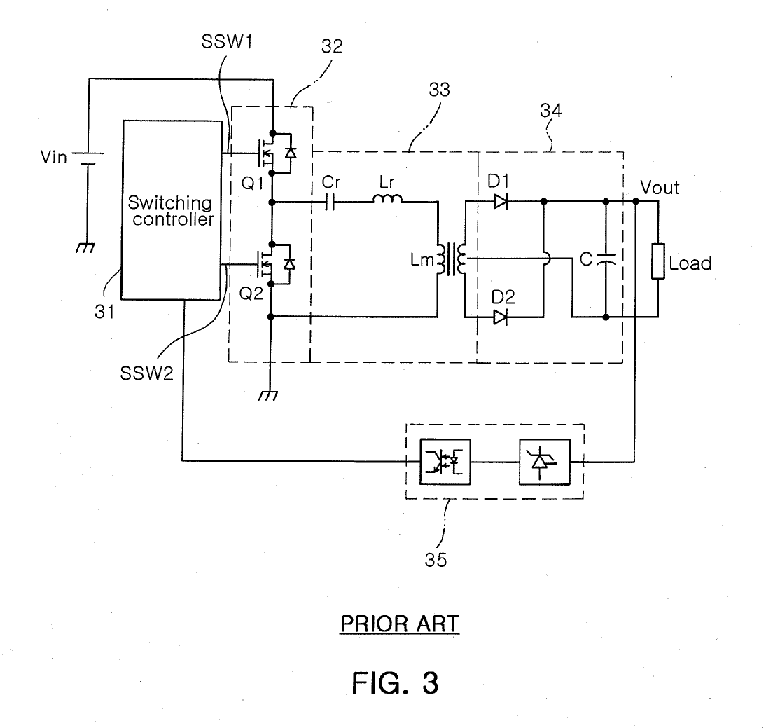

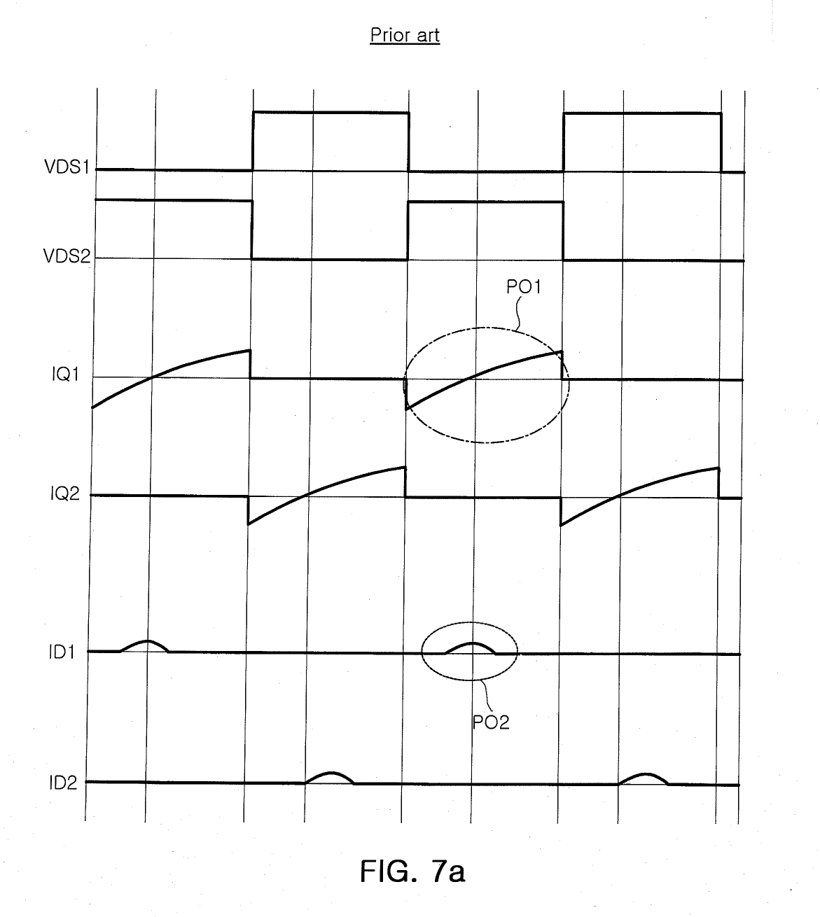

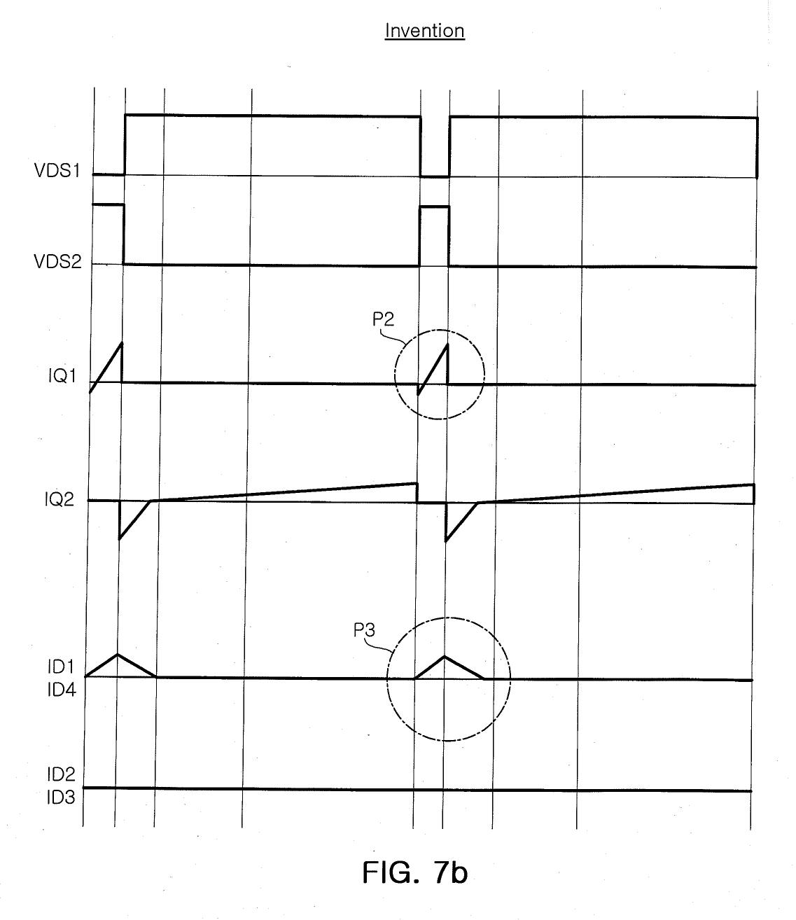

FIGS. 7a and 7b are waveform diagrams illustrating major signals of the conventional DC/DC converter of FIG. 3 and the DC/DC converter of the invention, respectively, at a minimum load. FIG. 7a plots waveforms of major signals of the conventional converter at a minimum load (Min load) in operating a variable frequency. FIG. 7b plots waveforms of major signals of the DC/DC converter of the invention at a minimum load (Min load) in operating the fixed frequency.

In FIG. 7b, P2 and P3 exhibit energy transferred to a secondary coil of the transformer, which is identical to that transferred to a primary coil thereof, at a minimum load. In FIG. 7a, PO1 and PO2 indicate little energy transferred to the secondary coil of the transformer at a minimum load.

In FIG. 5 and FIG. 7b, the first switching signal SSW1 and the second switching signal SSW2 each have a fixed frequency. The first and second switching signals SSW1 and SSW2 are inversely phased, thereby exhibiting different pulse width. Here, a high level of the first switching signal SSW1 does not overlap that of the second switching signal SSW2. Likewise, a low level of the first switching signal SSW1 does not overlap that of the second switching signal SSW2. VDS1 is an interstage voltage between a source and a drain of the first switch Q1 for switching on/off in response to the first switching signal SSW1. The VDS2 is an interstage voltage between a source and a drain of the second switch Q2 for switching on/off in response to the second switching signal SSW2. IQ1 is current flowing through the first switch Q1 and IQ2 is current flowing through the second switch Q2. Also, ID1 to ID4 are current flowing through respective bridge diodes D1 to D4 of the rectifier 400.

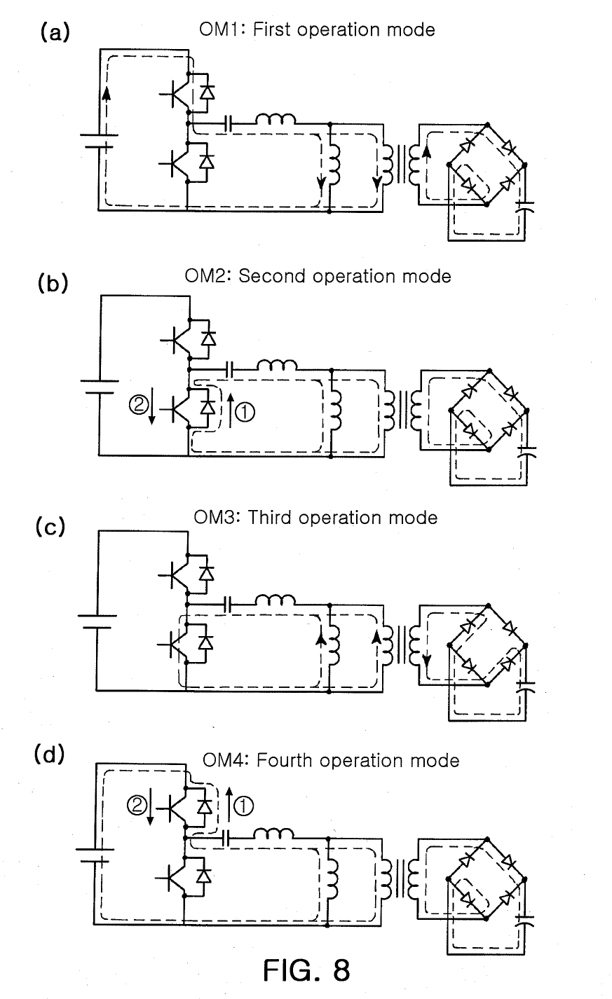

FIGS. 8 (a) to (d) are circuit diagrams corresponding to switching operation of FIG. 4.

FIG. 8 (a) is a current flow when a converter of the invention is in a first operation mode. FIG. 8 (b) is a current flow when the converter of the invention is in a second operation mode. FIG. 8 (c) is a current flow when the converter of the invention is in a third operation mode. Also, FIG. 8 (d) is a current flow when the converter of the invention is in a fourth operation mode.

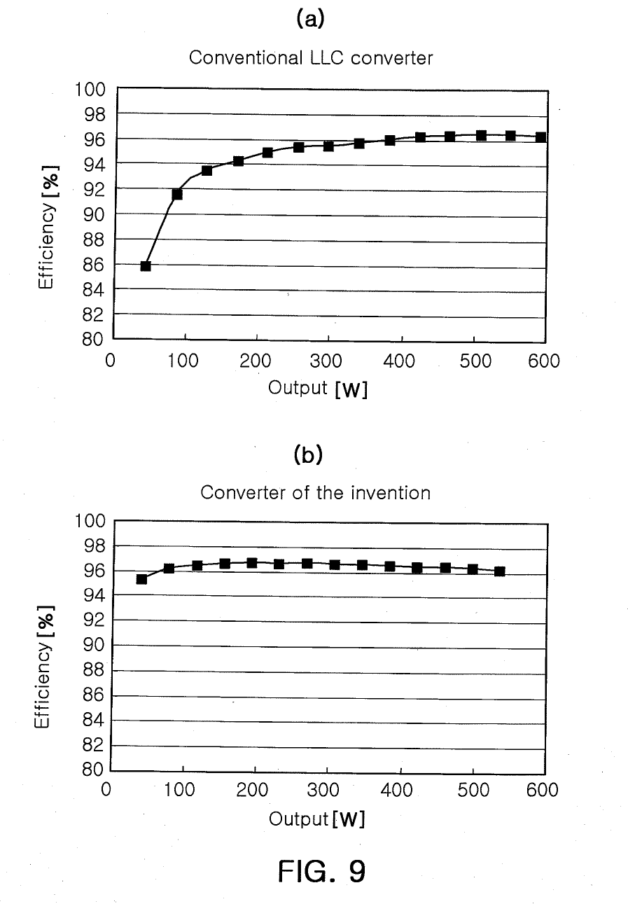

FIGS. 9 (a) and (b) are graphs illustrating efficiency properties of a conventional resonant DC/DC converter and a DC/DC converter of the invention, respectively.

FIG. 9 (a) is a graph illustrating efficiency properties of the conventional converter and FIG. 9 (b) is a graph illustrating efficiency properties of the converter of the invention.

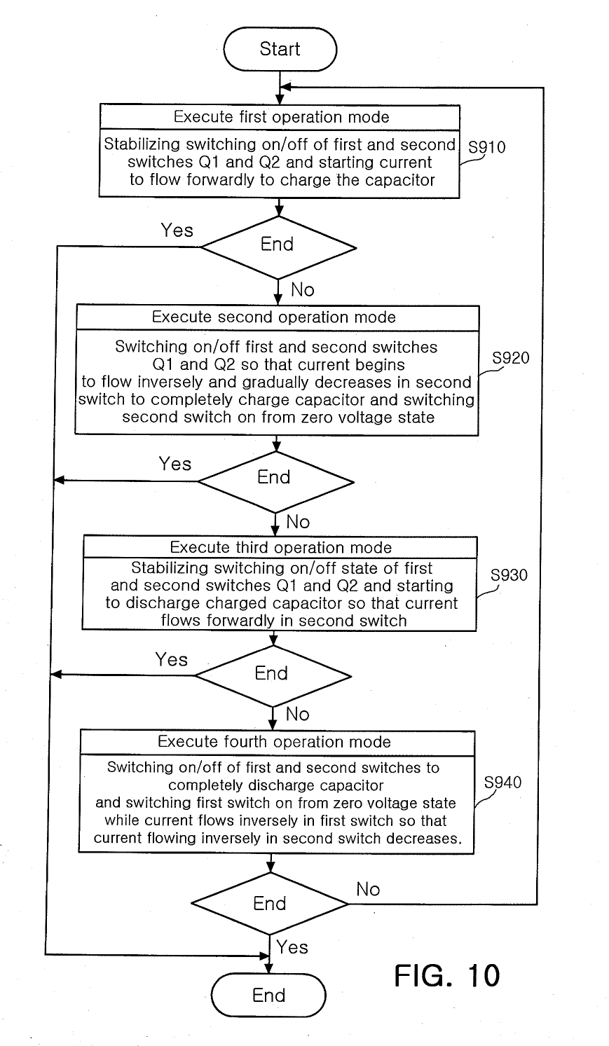

FIG. 10 is a flowchart illustrating a method for controlling a high-efficiency half-bridge DC/DC converter of the invention.

In FIG. 10, the first mode is executed in S910, in which switching on/off state of the first and second switches are stabilized and current starts to flow forwardly to charge the capacitor.

The second mode is executed in S920, in which the first and second switches are switched on/off so that current begins to flow inversely and gradually decreases in the second switch to completely charge the capacitor and the second switch is switched on from a zero voltage state.

The third mode is executed in S930, in which the switching on/off state of the first and second switches are stabilized and the charged capacitor starts to discharge so that current flows forwardly in the second switch.

Then, the fourth mode is executed in S940, in which the first and second switches are switched on/off to completely discharge the capacitor and the first switch is switched on from the zero voltage state while current flows inversely in the first switch so that current flowing inversely in the first switch decreases.

A detailed explanation will be given hereunder about operations and effects of the invention with reference to the accompanying drawings.

The invention will be explained with reference to FIGS. 4 to 10.

In FIG. 4, a controller 100 of the invention provides asymmetric first and second switching signals SSW1 and SSW2 having a fixed frequency. Here, a high level of the first switching signal SSW1 does not overlap that of the second switching signal SSW2. Likewise, a low level of the first switching signal SSW1 does not overlap that of the second switching signal SSW2. Pulse width of the first and second switching signals SSW1 and SSW2 is controlled in a PWM mode and can be varied in the PWM mode depending on size of an output voltage. A first switch Q1 of a switching part 200 switches on/off in response to the first switching signal SSW1 and a second switch Q2 of the switching part 200 switches on/off in response to the second switching signal SSW2.

Then, a transformer 300 is synchronized with switching operation of the switching part 200 to resonate. Also the transformer 300 transforms a voltage applied to a first winding into a second winding at a winding ratio. A rectifier 400 of the invention rectifies the voltage from the transformer 300 into a direct voltage. In addition, a feedback circuit 500 of the invention detects the voltage outputted via the rectifier and provides the detected voltage to the controller 100, thereby maintaining it at a predetermined level.

At this time, the controller 100 varies pulse width of the first and second switching signals SSW1 and SSW2 in the PWM mode based on the voltage detected by the feedback circuit 500 and controls the voltage outputted from the rectifier 400 to stay at a predetermined level.

In this high-efficiency half-bridge DC/DC converter of the invention, the switching controller 100, as just described, provides first and second switching signals SSW1 and SSW2 having the fixed frequency. Here, a high level of the first switching signal SSW1 does not overlap that of the second switching signal SSW2. Likewise, a low level of the first switching signal SSW1 does not overlap that of the second switch signal SSW2. Also the switching controller 100 provides power Vin to the switching part 200. The switching controller 100 executes the first to fourth operation modes OM1 to OM4 according to levels of the first and second switching signals SW1 and SW2. The first to fourth operation modes will explained hereunder with reference to FIGS. 4 to 10.

Referring to FIGS. 4 to 10, in the first operation mode OM1, the first and second switching signals SSW1 and SSW2 each are stabilized into a high level and a low level, and accordingly, the first and second switches Q1 and Q2 are stabilized into an on and off state.

That is, as shown in FIGS. 4 and 5, if the first and second switching signals SSW1 and SSW2 each are stabilized into a high level and a low level, the first switch Q1 is stabilized into an on state and the second switch Q2 is stabilized into an off state. Thus current begins to flow forwardly through the first switch Q1 to charge the capacitor Cr and no current IQ2 flows through the second switch Q2.

As a result, the first switch Q1 exhibits a low level of a drain-source voltage VDS1 and the second switch Q2 exhibits a high level of a drain-source voltage VDS2.

An explanation will be given about a first current loop of the transformer in the first operation mode with reference to FIG. 4 and FIG. 8 (a).

Referring to FIG. 4, if the first switch Q1 is stabilized into an on-state and the second switch Q2 is stabilized into an off-state, current from a primary coil of the transformer 300, as shown in FIG. 8 (a), flows through the first switch Q1, a capacitor Cr and coils Lr, Lm.

Therefore, current from a secondary coil of the transformer 300 flows through the first and fourth diodes D1 and D4 of the rectifier 400 as in S910 of FIG. 10.

Next, in the second operation mode OM2, the first and second switching signals SSW1 and SSW2 each transit to a low level and a high level, and the first and second switches Q1 and Q2 switch on/off.

That is, as shown in FIGS. 4 and 5, the first and second switching signals SSW1 and SSW2 each transit to a low level and a high level. Then, current flows inversely through a body diode of the second switch Q2 and the second switch Q2 is turned on from a zero voltage state to thereby execute zero voltage switching (ZVS). Thus the capacitor Cr is completely charged and the first switch is turned off.

Accordingly, no current IQ1 flows through the switch Q1, and current IQ2 flowing through the body diode of the second switch Q2 gradually decreases. Here, the first switch Q1 has a high level of a drain-source voltage VDS1 and the second switch Q2 has a low level of a drain-source voltage VDS2.

Furthermore, an explanation will be given about the first current loop of the transformer in the second operation mode with reference to FIGS. 4 and 8 (b).

Referring to FIG. 4, if the first and second switching signals SSW1 and SSW2 each transit to a low level and a high level, the first and second switches Q1 and Q2 are turned on/off. This eliminates an existing current loop. Also, with the second switch Q2 turned on, current flowing through the second switch Q2, as shown in FIG. 8 (b), flows through the second switch Q2, the primary coil Lr and Lm of the transformer 300 and the capacitor Cr.

Accordingly, current in the primary coil of the transformer 300 flows through the first and fourth diodes D1 and D4 of the rectifier 400 as shown in S920 of FIG. 10.

Meanwhile, if the first switch Q1 is turned off and the second switch Q2 is stabilized into an on-state, the second operation mode OM2 proceeds to the third operation mode OM3, and rectifying diodes D1 to D4 of the rectifier execute zero current switching ZCS by current resonance of the transformer.

Thereafter, in the third operation mode OM3, the first and second switching signals SSW1 and SSW2 each are stabilized into a low level and a high level, and the first and second switches Q1 and Q2 are stabilized into an on/off state.

That is, as shown in FIGS. 4 and 5, if the first and second switching signals SSW1 and SSW2 each are stabilized into a low level and a high level, the first switch Q1 is stabilized into an off state and the second switch Q2 is stabilized into an on state. Then, the capacitor Cr starts to discharge. Also, no current IQ1 flows through the switch Q1 and current IQ2 flowing through the second switch Q2 increases and then decreases.

As a result, the first switch Q1 exhibits a high level of a drain-source voltage VDS1 and the second switch Q2 exhibits a low level of a drain-source voltage VDS2.

An explanation will be given hereunder about the first current loop of the transformer in the third operation mode with reference to FIGS. 4 and 8.

Referring to FIG. 4, as described above, if the first and second switching signals SSW1 and SSW2 each are stabilized into a low level and a high level, the first and second switches Q1 and Q2 are stabilized into an off/on state. At this time, current in the primary coil L1 of the transformer 300, as described in FIG. 8 (c), flows through the second switch Q2, the primary coil of the transformer 300, and the coils Lr and Lm. Also, current in the primary coil of the transformer 300 flows through second and third diodes D2 and D3 of the rectifier 400 as in S930 of FIG. 10.

In the third operation mode as just described, as shown in FIG. 6, at a zero current state, the first and fourth diodes D1 and D2 of the rectifier 400 are turned off and the second and third diodes D2 and D3 of the rectifier 400 are turned on, thereby achieving zero current switching (ZCS). The zero current switching reduces switching stress of the diode of the rectifier 400.

Also, in the fourth operation mode OM4, the first and second switching signals SSW1 and SSW2 each transit to a high level and a low level so that the first and second switches Q1 and Q2 are turned on/off.

That is, as shown in FIGS. 4 and 5, if the first and second switching signals SSW1 and SSW2 each transit to a high level and a low level, current begins to flow inversely through the body diode of the first switch Q1 so that the first switch Q1 is turned on from a zero voltage state, achieving the zero current switching. Thereby, the capacitor Cr completely discharges and then the second switch Q2 switches off.

Accordingly, current IQ1 flowing through the body diode of the first switch decreases gradually and no current IQ2 flows through the second switch Q2. Furthermore, the first switch Q1 has a low level of a drain-source voltage VDS1 and the second switch Q2 has a high level of a drain-source voltage VDS2.

An explanation will be given hereunder about the first current loop of the transformer in the fourth operation mode with reference to FIGS. 4 and 8 (d).

Referring to FIG. 4, if the first and second switching signals SSW1 and SSW2 each transit to a high level and a low level, the first and second switches Q1 and Q2 switch on/off. This eliminates an existing current loop. With the first switch Q1 turned on, current flowing through the first switch Q1, as shown in FIG. 8 (d), flows through the first switch Q1, the capacitor Cr and the coils Lr and Lm.

Therefore, current in the primary coil of the transformer 300 flows through the second and third diodes D2, D3 of the rectifier 400 as in S940 of FIG. 10.

Meanwhile, if the second switch Q2 is stabilized into an off state and the first switch Q1 is stabilized into an on state, the fourth operation mode OM4 is again followed by the first operation mode. Then, the rectifying diode of the rectifier achieves the zero current switching (ZCS) by current resonance in the transformer.

As described above, in comparison of FIGS. 7a and 7b, the high-bridge DC/DC converter of the invention exhibits higher efficiency that the conventional converter, as noted in Table 1.

TABLE 1

| | Conventional (variable | Inventive (fixed |
|---|---|---|
| | frequency resonance) | frequency resonance) |
| Efficiency | Low (at a minimum load | High (at a minimum load |
| | (FIG. 7b)) | (FIG. 7a)) |
| Properties | Low efficiency at a low | High efficiency at all |
| | load | loads |
| Application | Unsuitable in case of big | Suitable for SMPS for PDP |
| | load variations | with big load variations |

Referring to PO1 and PO2 of FIG. 7a, the conventional variable frequency type converter experiences increase in switching frequency at a minimum load, thus excessively shortening switching time. This prevents circulating current from a primary coil of the variable frequency type transformer from being sufficiently transferred to a secondary coil of the transformer, thereby increasing reactive power. When compared with FIG. 7b, the conventional variable frequency type converter exhibits relatively lower efficiency at a minimum load than the converter of the invention.

In contrast, referring to P2 and P3 of FIG. 7b, the fixed frequency type converter of the invention demonstrates uniform switching time regardless of load. Therefore sufficient switching time is assured even at a minimum load and accordingly, circulating current from the primary coil of the transformer is sufficiently transferred to the secondary coil of the transformer, thereby increasing active power. Given such operation, the converter of the invention shows high efficiency at a minimum load.

The converter of the invention described above operates with high efficiency, especially even at a minimum load. This will be explained hereunder with reference to FIG. 9.

Referring to FIG. 9 (a), the conventional converter operates with less than 90% efficiency at a load of 80 W or less but with 96% or more only at a load of 380 W to 500 W. In contrast, referring to FIG. 9 (b), the converter of the invention operates with 96% or more efficiency at a load of 50 W to 500 W. This confirms that the converter of the invention can be suitably used for a sustain voltage part for PDP having big load variations.

According to this disclosure of the invention as described above, a high-efficiency half-bridge DC/DC converter of the invention is applied to a power supply of displays such as PDP or LCD. The converter of the invention employs a fixed switching frequency, a PWM mode, and current resonance. Therefore, when adopted in the power supply such as an SMPS for PDP having big load variations, the converter of the invention ensures high efficiency in the entire range from a minimum load to a maximum load, thereby relieving switching stress of a rectifying diode.

While the present invention has been shown and described in connection with the preferred embodiments, it will be apparent to those skilled in the art that modifications and variations can be made without departing from the spirit and scope of the invention as defined by the appended claims.

What is claimed is:

1. A high efficiency half-bridge DC/DC converter comprising:
a switching part having first and second switches serially connected from a power supply to a ground, the first and second switches switching on/off in response to first and second switching signals having a fixed frequency, the first switching signal having a phase level that does not overlap a corresponding phase level of the second switching signal;
a transformer for transforming a voltage applied to a first winding into a second winding in response to switching operation of the switching part, and resonating by an inductor and a capacitor of the first winding;
a rectifier including a rectifying diode for rectifying the voltage from the transformer into a direct voltage;
a feedback circuit for detecting the voltage outputted via the rectifier; and
a controller for controlling pulse width of the first and second switching signals in a pulse width modulation mode according to the voltage detected by the feedback circuit.

2. The high efficiency half-bridge DC/DC converter according to claim 1, wherein the controller sequentially controls the pulse width of the first and second switching signals, in a first operation mode, by stabilizing switching on/off state of the first and second switches and starting current to flow forwardly to charge the capacitor, in a second operation mode, by switching on/off the first and second switches so that current begins to flow inversely and gradually decreases in the second switch to completely charge the capacitor, a third operation mode, by stabilizing the switching on/off state of the first and second switches and starting to discharge the charged capacitor so that current flows forwardly in the second switch, and in a fourth operation mode, by switching on/off the first and second switches to completely discharge the capacitor.

3. The high efficiency half-bridge DC/DC converter according to claim 2, wherein the first switch is in a zero voltage state while current flows inversely through a body diode at off state, and switches on from the zero voltage state.

4. The high efficiency half-bridge DC/DC converter according to claim 2, wherein the second switch is in a zero voltage state when current flows inversely through the body diode at off state, and switches on from the zero voltage state.

5. The high efficiency half-bridge DC/DC converter according to claim 2, wherein current flowing in the rectifying diode is synchronized with resonance of the transformer so that the rectifying diode in the rectifier executes zero-current switching.

6. A method for controlling a high efficiency half-bridge DC/DC converter, which includes a switching part having first and second switches serially connected from a power supply to a ground, a transformer for transforming a voltage applied to a first winding into a second winding in response to switching operation of the switching part, and resonating by an inductor and a capacitor of the first winding, a rectifier having a rectifying diode for rectifying the voltage from the transformer into a direct voltage, and a controller for controlling pulse width of the first and second switching signals having a fixed frequency in a pulse width modulation mode, the method executing:
a first operation mode of stabilizing switching on/off state of the first and second switches and starting current to flow forwardly to charge the capacitor;
a second operation mode of switching on/off the first and second switches so that current begins to flow inversely and gradually decreases in the second switch to completely charge the capacitor and switching the second switch on from a zero voltage state;
a third operation mode of stabilizing the switching on/off state of the first and second switches and starting to discharge the charged capacitor so that current flows forwardly in the second switch; and
a fourth operation mode of switching on/off the first and second switches to completely discharge the capacitor and switching the first switch on from the zero voltage state while current flows inversely in the first switch so that current flowing inversely in the first switch decreases,
wherein the first, second, third and fourth operation modes are executed consecutively and cyclically.
